(19) United States
(12) Patent Application Publication
(10) Pub. No.: US 2008/0000276 A1
(43) Pub. Date: Jan. 3, 2008

(54) Multi-point-door-lock electric locking device

(76) Inventor: Tsao-Hui Huang, Taipei County (TW)

Correspondence Address: Tsao-Hui Huang, P.O. Box 44-2049, Taipei, 10668, omitted

(21) Appl. No.: 11/812,822

(22) Filed: Jun. 22, 2007

(30) Foreign Application Priority Data
Jun. 28, 2006 (TW) 095211250

(51) Int. Cl. E05B 47/00; E05B 65/00

(52) U.S. Cl. 70/91; 70/279.1

(57) ABSTRACT

In a multi-point-door-lock electric locking device, an actuator, such as an electric motor, is disposed on the door lock. When the door lock is to be locked, the electric motor may rotate to perform the multi-point door locking function by only turning on an electric motor switch without using a manual key.

### BACKGROUND OF THE INVENTION

(1) Field of the Invention

The invention relates to a multi-point-door-lock electric locking device, and more particularly to an electric locking device capable of performing the multi-point locking function of a door lock using an electric motor to rotate an electric key without using a manual key.

(2) Description of the Prior Art

In the present structure of the multi-point door lock, multiple metal locking sheets having the thickness of about 1.2 mm are adopted to lock a deadbolt so that the deadbolt is constrained by the metal locking sheetsand cannot be moved freely. If the deadbolt has to be actuated to perform the locking or unlocking operation, a key has to be utilized to move away the metal locking sheets, which lock the deadbolt, so that the deadbolt gets rid of the control of the metal locking sheets and the locking and unlocking operations can be performed. So, it is quite inconvenient in use, and the prior art still has to be improved. In view of this, the present invention provides a utility and novel multi-point-door-lock electric locking device in order to improve the conventional drawbacks according to the professional knowledge and spirit and the long term of test, research and development.

### SUMMARY OF THE INVENTION

The invention provides a multi-point-door-lock electric locking device, in which multiple metal locking sheets are provided, and two locking posts on two sides of a deadbolt are fit with slots of the locking sheets. Because the deadbolt and the locking posts are combined together, the deadbolt is constrained by the metal locking sheets and cannot be moved freely. The invention adopts an actuator, such as a solenoid or an electric motor, to move away the metal locking sheets locked with the deadbolt so that the deadbolt cannot be constrained by the metal locking sheets and a free state can be obtained. Meanwhile, the spring disposed on the deadbolt can eject the deadbolt out so that the deadbolt is inserted into a doorframe. If the multi-point design is used, the door lock can be locked point-by-point using the power. In order to achieve the function of multi-point locking the door lock, the conventional structure of the door lock is improved such that the rotating electric motor can achieve the locking function.

Further aspects, objects, and desirable features of the invention will be better understood from the detailed description and drawing that follows in which various embodiments of the disclosed invention are illustrated by way of examples.

### BRIEF DESCRIPTION OF THE DRAWING

FIG. 1 shows a multi-point electric locking device.

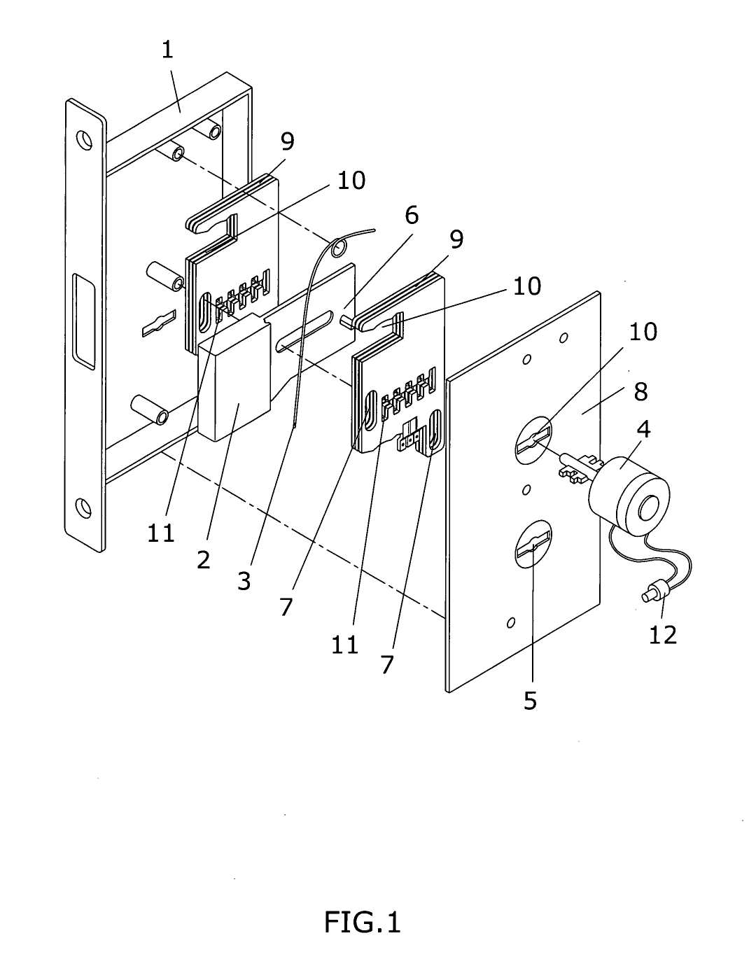

### DETAILED DESCRIPTION OF THE PREFERRED EMBODIMENTS

The present invention will be apparent from the following detailed but non-limitative description, which proceeds with reference to the accompanying drawing, wherein the same references relate to the same elements.

### Vertical Mode

When the lock is to be locked, only an electric motor switch 12 disposed on the door lock has to be turned on. Then, an electric motor rotates an electric key 8 connected to a shaft of the electric motor. Since the electric key is inserted into electric key holes 10 of metal locking sheets 9, two sides of the electric key may press the metal locking sheets 9 when the electric key is rotated. Since the notches on two sides of the key have different depths, which are the designs of the passwords of the key, the locking sheets are correspondingly moved by a distance corresponding to the depth of each of the notches of the key when the metal locking sheets are pressed. This distance variations cause slots 11 of the locking sheets to make six sheets be in the same mode so that the locking post 6 on the deadbolt is not locked by the sawtooth-like slots 11 and can be completely separated. At this time, a spring 3 disposed on the deadbolt ejects the deadbolt 2 so that the door lock can be automatically locked by the electric key 8 rotated by the electric motor 4. In this mode, the moving direction of the locking sheets is perpendicular to the deadbolt 2, so the mode is named as a vertical mode.

### Horizontal Mode

When the lock is to be locked, only the metal locking sheets 9 attached to the deadbolt 2 have to be pushed outwards and away from the deadbolt 2 by the distance greater than 6 mm synchronously according to the power and the mechanical structure. This distance is greater than the height (about 5 mm) of the locking post disposed on the deadbolt 2. So, the locking post on the deadbolt 2 completely gets rid of the control of the locking sheets and enters the free state. Meanwhile, the spring attached to the deadbolt ejects the deadbolt so that the deadbolt is inserted into the doorframe to complete the locking operation. The moving direction of the metal locking sheets 9 is the horizontal direction and is parallel to the deadbolt 2, so the mode is named as a horizontal mode.

New characteristics and advantages of the invention covered by this document have been set forth in the foregoing description. It is to be expressly understood, however, that the drawing is for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A multi-point-door-lock electric locking device, comprising:
a door lock having one deadbolt or multiple deadbolts;
an electric motor, which is an AC or DC electric motor and provides a power;
an electric motor switch, often disposed on a panel of the door lock, for turning on the electric motor;
an electric key, which is connected to a shaft of the electric motor, often disposed inside the door lock, and powered by the electric motor to perform an auto-locking function;
an electric key hole formed on the panel of the door lock facing an inside of a house, wherein the electric key connected to the shaft of the electric motor may be inserted into the electric key hole to perform the auto-locking function when the electric motor rotates;
a manual key hole formed on the panel of the door lock facing an outside of the house, wherein a manual key may be inserted into the manual key hole to perform a manual locking function and a manual unlocking function.

2. The device according to claim 1, wherein the electric motor switch may be turned on to perform the auto-locking function when a user goes out.
